(19) United States
(12) Patent Application Publication
(10) Pub. No.: US 2011/0280312 A1
(43) Pub. Date: Nov. 17, 2011

(54) VIDEO PROCESSING DEVICE WITH MEMORY OPTIMIZATION IN IMAGE POST-PROCESSING

(75) Inventors: Alok GAUR, Germantown, MD (US); Vivekanand Chengalvala, Germantown, MD (US)

(73) Assignee: Texas Instruments Incorporated, Dallas, TX (US)

(21) Appl. No.: 12/779,141

(22) Filed: May 13, 2010

(51) Int. Cl. H04N 7/12

(52) U.S. Cl. 375/240.25; 375/E07.026

(57) ABSTRACT

A video processing device is disclosed that includes a processor unit with a processor and a memory having a reorder buffer. The processor includes a reorder module, a frame rate conversion module, and post-processing function modules. The reorder, frame rate conversion, and post-processing modules access video frames stored in the reorder buffer, while the video frames are stored in the reorder buffer, and reorder, adjust the frame rate, and perform image processing, respectively, on the video frames, while the video frames are stored in the reorder buffer. A method implemented on such a video processing device is also disclosed. A computer-readable storage medium with instructions stored thereon for performing the method is also disclosed.

### TECHNICAL FIELD

The technical field of the present application relates to video frame processing, and more specifically to the optimization of memory in post-processing in a video frame processing device.

### BACKGROUND

Video processing devices such as media gateway devices typically receive streamed compressed video frames over a network. The order in which the video frames are streamed (stream order) is different from the order in which the video frames are ultimately displayed (display order). In order to convert the received video frames from stream order into display order, the video frame images need to be buffered in a reorder buffer.

FIG. 4 illustrates a processor unit 401 of a conventional media gateway/server device that reorders streamed video frames. The processor unit 401 includes a network interface 403, a decoder 405, a reorder buffer 407, a frame rate conversion (FRC) unit 409, a transizing unit 411, an overlay unit 413, an other post-processing functions unit 415, and an encoder 417. Video frames that are streamed from another device on a network are first received through the network interface 403. Examples of such a network interface might include a modem, a network interface card, or similar functioning components.

Once received at the network interface 403, the streamed video frames are decoded by the decoder 405, and at least a portion of the video frames are stored in the reorder buffer 407. The processing unit 401 operates to reorder the video frames stored in the reorder buffer 407 into a display order. Conventionally, the FRC unit 409 processes individual frames in the reorder buffer 407, and either repeats frames or drop frames in order to adjust a frame rate.

More particularly, the FRC unit 409 conventionally receives individual frames one at a time from the reorder buffer 407, and either repeats frames when the frame rate needs to be increased or drops frames when the frame rate needs to be decreased. In FIG. 4, the video frames are further modified by various post-processing function units such as the transizing unit 411 and the overlay unit 413. It should be noted that the transizing unit 411 and the overlay unit 413 are but two examples of post-processing modifications that can be made. Other post-processing modifications are collectively represented in the other post-processing functions unit 415.

Typically, post-processing units such as the transizing unit 411 and the overlay unit 413 are portable modules that can be implemented on a variety of devices. As such, each of the post-processing modification units 411, 413, 415 that makes a modification to video frames conventionally copies each video frame in an additional memory buffer (not shown). Each post-processing modification unit 411, 413, 415 also will typically store each video frame according to a different protocol. Additional processing power is thus required to convert each individual video frames among the various protocols as each individual video frame is modified by the various post-processing modification units 411, 413, 415. Nonetheless, after each video frame has been manipulated by the post-processing modification units 411, 413, 415, the video frames are encoded by the encoder 417 and output across the network through the network interface 403.

The conventional processor unit 401 illustrated in FIG. 4 stands to be improved. Initially, the repetition and deletion of frames by the FRC unit 409 produces jerky motion in video reproduction. This condition is inadequate where image quality and smooth motion are important. Further, the additional memory and processing power required by each post-processing modifications unit 411, 413, 415 to store individual video frames is an inefficient use of limited processor resources that could be used for other purposes.

### SUMMARY

Accordingly, one embodiment described herein relates to a video processing device including a processor and a memory. The processor includes a decoder that decodes a plurality of video frames. The memory includes a reorder buffer that stores the plurality of video frames decoded by the decoding module. The processor further includes a reorder module that accesses the plurality of video frames while the plurality of video frames are stored in the reorder buffer, and reorders the plurality of video frames, while the plurality of video frames are stored in the reorder buffer, from a streamed order into a display order. The processor also includes a frame rate conversion module that accesses the plurality of video frames while the plurality of video frames are stored in the reorder buffer, and adjust a frame rate, by interpolating frames from the plurality of video frames, while the plurality of video frames are stored in the reorder buffer. The processor further includes one or more post processing module that accesses the plurality of video frames while the plurality of video frames are stored in the reorder buffer, and makes one or more post-processing modification to the plurality of video frames, while the plurality of video frames are stored in the reorder buffer. The processor finally includes an output module that outputs from the video processing device, in display order, the plurality of video frames stored in the reorder buffer.

A second embodiment described herein relates to a method implemented in a video processing device that includes a processor and a memory. The method includes decoding a plurality of video frames and storing the plurality of video frames decoded by the decoding module in a reorder buffer in the memory. The method further includes accessing the plurality of video frames while the plurality of video frames are stored in the reorder buffer, and reordering the plurality of video frames, while the plurality of video frames are stored in the reorder buffer, from a streamed order into a display order. The method also includes accessing the plurality of video frames while the plurality of video frames are stored in the reorder buffer, and adjusting a frame rate by interpolating frames from the plurality of video frames, while the plurality of video frames are stored in the reorder buffer. The method additionally includes accessing the plurality of video frames while the plurality of video frames are stored in the reorder buffer, and making one or more post-processing modification to the plurality of video frames, while the plurality of video frames are stored in the reorder buffer. The method finally describes outputting from the video processing device, in display order, the plurality of frames stored in the reorder buffer. Another embodiment of the present application is a computer-readable storage medium with instructions stored thereon, that when executed by a processor in a video processing device, perform the method described in the paragraph above.

It should be noted that foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying figures where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 is a block diagram illustrating a processor unit utilizing a reorder buffer that is accessed by an FRC unit and a plurality of post-processing units.

FIG. 2 is a block diagram illustrating a video processing device that utilizes a reorder buffer that is accessed for FRC and for a plurality of post-processing functions.

FIG. 3 is a flow chart illustrating a video processing method implemented in a video processing device that utilizes a reorder buffer that is accessed for FRC and for a plurality of post-processing functions.

FIG. 4 is a block diagram illustrating a conventional processor unit utilizing a reorder buffer for reordering video frames.

### DETAILED DESCRIPTION

In overview, the present disclosure concerns a video processing device that operates typically (although not necessarily always) as a media gateway device or media server that is associated with networks supporting streaming of video images. More particularly, various inventive concepts and principles are embodied in devices, processing units, computer-readable storage mediums, and methods that utilize a reorder buffer that is accessed for FRC and for a plurality of post-processing functions. The instant disclosure is thus provided to further explain in an enabling fashion the best modes of performing the one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e. processes or steps that are not so limited may be performed in any order.

Much of the inventive functionality and many of the inventive principles when implemented, are best supported with or in software or integrated circuits (ICs), such as a digital signal processor and software therefore, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring principles and concepts, further discussion of such software and ICs, if any, will be limited to the essentials with respect to the principles and

As further discussed herein below, various inventive principles and combinations thereof are advantageously employed to provide a video processing device with a processing unit that includes a reorder buffer that is accessed while a plurality of video frames are stored in the reorder buffer, in order to reorder the plurality of video frames from a streamed order into a display order, while the plurality of video frames are stored in the reorder buffer. The reorder buffer is further accessed, while the plurality of video frames are stored in the reorder buffer, in order to adjust a frame rate, by interpolating frames from the plurality of video frames, while the plurality of video frames are stored in the reorder buffer. The reorder buffer is additionally accessed, while the plurality of video frames are stored in the reorder buffer, in order to make one or more post-processing modification to the plurality of video frames, while the plurality of video frames are stored in the reorder buffer.

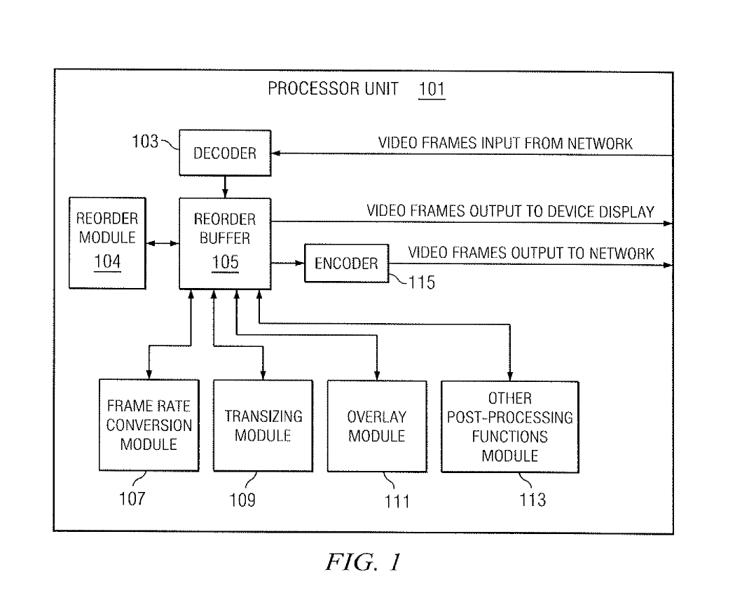

Referring now to FIG. 1, a block diagram illustrating a processor unit utilizing a reorder buffer that is accessed by an FRC unit and a plurality of post-processing units is discussed and described. The processor unit 101 includes a decoder 103, a reorder buffer 105, a reorder module 104, an FRC module 107, a transizing module 109, an overlay module 111, an other post-processing functions module 113, and an encoder 115. The operation of the processor unit 101 is now described.

As is seen in FIG. 1, the processor unit 101 receives video frames from across a network, the video frames being input to a device housing the processor unit 101. Exemplary networks might include, by way of example, the Internet, intranets, local area networks (LAN), wireless LANs (WLAN), wide area networks (WAN), and others. Protocols supporting the video frames transfer may include one or more of various networking protocols, such as TCP/IP (Transmission Control Protocol/Internet Protocol), Ethernet, X.25, Frame Relay, ATM (Asynchronous Transfer Mode), IEEE 802.11, UDP/UP (Universal Datagram Protocol/Universal Protocol), IPX/SPX (Inter-Packet Exchange/Sequential Packet Exchange), Net BIOS (Network Basic Input Output System), GPRS (general packet radio service), I-mode and other wireless application protocols, and/or other protocol structures, and variants and evolutions thereof.

Once the video frames are received at the processor unit 101, the video frames are decoded by decoder 103. That is to say, when the video frames are received across the network, they arrived in a compressed format according to a compression standard. As is well known, the compression standards are established primarily by a few international organizations including the International Organization for Standardization (IOS)/Motion Picture Experts Group (MPEG), the International Telecommunication Union Standardization Section (ITU-T), and the International Electrotechnical Commission (IEC). The decoder 103 operates according to the appropriate compression standard to (as is known in the art) decompress the video frames received at the processor unit 101.

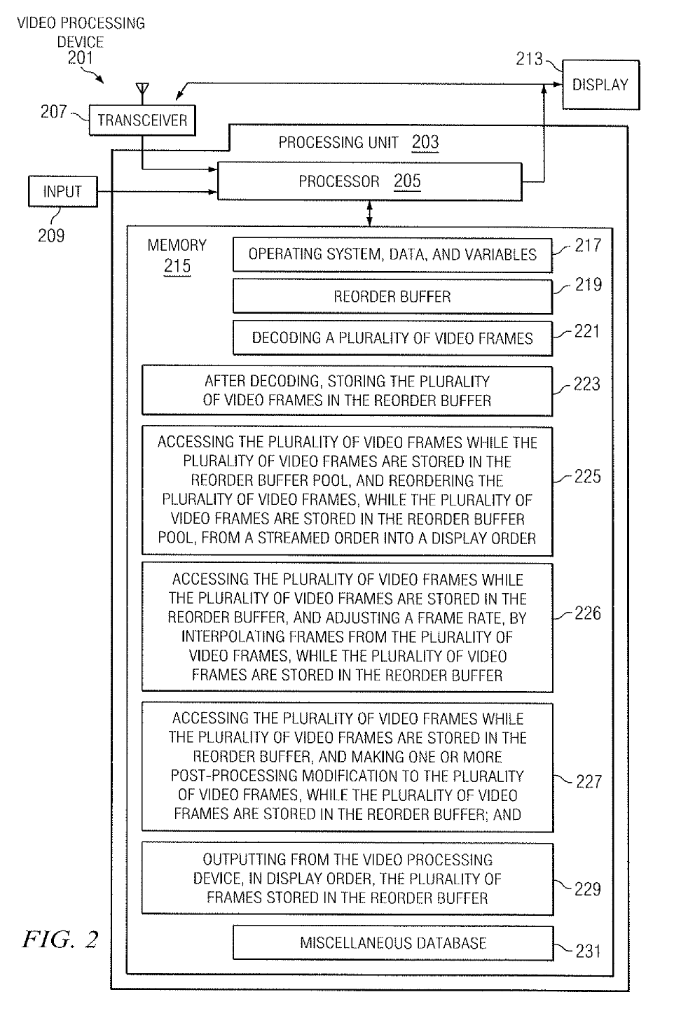

After the video frames are decoded, the processor unit 101 operates to store the video frames in the reorder buffer 105. The reorder buffer 105 may be formed of known data storage technologies such as those described below in relation to memory 215 in FIG. 2. Conventionally, the reorder buffer 105 is a pre-defined area of memory, typically a lower order, fast access address (e.g., direct memory access) that may store between 6 and 12 video frames at any time. The reorder buffer 105 provides read/write access to the reorder module 104, the frame rate conversion module 107, the transizing module 109, the overlay module 111, and the other post-processing functions module 113. The operation of these modules, as they related to the reorder buffer 105, is described further below.

The order in which the video frames are streamed across a network is different from the order in which the video frames are ultimately displayed. The video frames stored in the reorder buffer 105 are arranged into a display order before being output across the network or displayed in the device in which the processor unit 101 is housed. The reorder module 104 of the processor operates to reorder the video frames stored in the reorder buffer 105 into a display order. That is to say, the reorder module 104 accesses a plurality of video frames while the plurality of video frames are stored in the reorder buffer 105, and reorders the plurality of video frames, while the plurality of video frames are stored in the reorder buffer 105, from a streamed order into a display order. This is represented in FIG. 1 by a bidirectional arrow that extends between the reorder buffer 105 and the reorder module 104.

In most instances, there is a difference in the rate at which frames are received by a video processing device and the rate at which the video frames are ultimately reproduced in another device. As described above, conventional FRC was done through repetition or deletion of frames. In contrast to the conventional process, embodiments of the present application allow for a frame rate conversion module 107 to access the plurality of video frames while the plurality of video frames are stored in the reorder buffer 105, and adjust a frame rate, by interpolating the plurality of video frames, while the plurality of video frames are stored in the reorder buffer 105. Interpolated frames may be added to the reorder buffer 105.

By way of explanation, in the processing unit 101, the FRC module 107 has access to not just one frame at a time but to the plurality of video frames stored in the reorder buffer 105. Because the FRC module 107 has such access, the FRC module can implement motion-compensated frame interpolation on the plurality of video frames, thereby estimating true motion between two images. In a nutshell, the FRC module 107 can generate video frames between existing stored frames in order to make video playback more fluid. It should also be noted that the terms interpolate and interpolation as used herein also includes the deletion and revision of video frames when it is necessary to reduce a frame rate.

FIG. 1 also illustrates various post-processing modules, including the transizing module 109, the overlay module 111, and the other post-processing functions module 113. The post-processing modifications change the perceived quality of video playback. These one or more post processing modules may access the plurality of video frames while the plurality of video frames are stored in the reorder buffer, and make one or more post-processing modification to the plurality of video frames, while the plurality of video frames are stored in the reorder buffer. One of ordinary skill in the art will understand that the transizing module 109, the overlay module 111, the other post-processing functions module 113, and the frame rate conversion module 107 are representative of various combinations of one or more post-processing modules.

Some of these post-processing operations help to reduce or hide image artifacts and flaws in the original film material. Other post-processing operations affect the size or shape of objects in the video playback. For example the transizing module 109 may operates to access the plurality of video frames, while the plurality of video frames are stored in the reorder buffer 105, and transizes the plurality of video frames, while the plurality of video frames are stored in the reorder buffer 105. Transizing is sometimes referred to as image scaling or multivariate interpolation (which should not be confused with the frame interpolation discussed above). Transizing changes the picture size in the video frames stored in the reorder buffer 105 when the output resolution of the video frames differs from the input resolution.

The overlay module 111 may operate to accesses the plurality of video frames while the plurality of video frames are stored in the reorder buffer 105, and to overlay content onto the plurality of video frames, while the plurality of video frames are stored in the reorder buffer 105. As is known in the art, the overlay content can include text, graphics, or combined texts and graphics, static graphics, animated text, and the like. The overlay module 111 may undertake to render and mix the overlay content with the plurality of video frames as part of the overlaying process, as is known in the art.

The other post-processing functions module 113 may operate to accesses the plurality of video frames while the plurality of video frames are stored in the reorder buffer 105, and perform other post-processing functions to the plurality of video frames, while the plurality of video frames are stored in the reorder buffer 105. The other post-processing functions module 113 is intended as representing what would be one or more other individual post-processing modules. That is to say, the other post-processing module is not a single module performing all the other post-processing functions. Rather, the other post-processing functions module 113 represents one or more other individual post processing modules that might be included in a particular processor unit 101. The other post processing modules might include modules for statistical-post-processing (SPP), deblocking, deranging, sharpening/unsharpening (often referred to as “softening”), requantizing, altering luminance, blurring/denoising, deinterlacing (e.g., the weave deinterlace method and/or the bob deinterlace method), and deflicking. This list is intended as exemplary, not exhaustive.

When post-processing modifications to the video frames stored in the reorder buffer 105 are complete, the processor unit 101 will output the video frames. The manner in which the video frames are output depends on whether the video processing device housing the processor unit 101 is acting as intermediate media gateway/server device or as a playback device. That is to say, the manner in which the files are output depends on whether the video processing device will be displaying the video frames on a device display of the video processing device or whether the video processing device will be further forwarding the video frames across the network.

As shown in FIG. 1, when video frames will be further forwarded across the network, the encoder 115 uses read only accesses (as indicated by the unidirectional arrow from the reorder buffer 105 to the encoder 115) to copy and encode the plurality of video frames stored in the reorder buffer. The encoder encodes the plurality of video frames into a compression format, and then outputs the compressed video frames so that they can be further streamed across the network. Conversely, if the video frames will be displayed in a device display of the video processing device housing the processor unit 101, the video frames are output from the reorder buffer 105 to the device display without any compression.

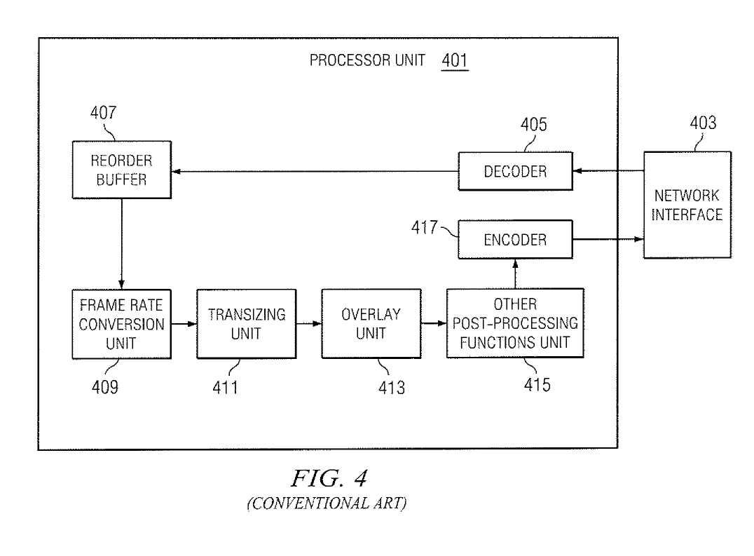

A processor unit 101 as illustrated in FIG. 1 is able to obtain at least two advantages over a conventional processor unit as illustrated in FIG. 4. Initially, and as described above, because the FRC module 107 can access a plurality of video frames while the video frames are stored in the reorder buffer 105, as opposed to accessing a single video frame at a time, the FRC module 107 can improve video quality by interpolating the video frames while they are stored in the reorder buffer 105. Secondly, because one or more post processing module (such as the transizing module 109, the overlay module 111, and the other post-processing functions module 113) can access the plurality of video frames while the plurality of video frames are stored in the reorder buffer 105, and makes one or more post-processing modification to the plurality of video frames, while the plurality of video frames are stored in the reorder buffer 105, processor memory can be more efficiently used as video frames are not copied for each post-processing module. Additionally, processing resources are not used in converting video frames among the various post-processing modules.

It should finally be noted that the reorder buffer 105 also has a dual purpose as temporary video frame holder. As is known to those of ordinary skill in the art, there is typically a difference in the throughput of the decoder 103 and the encoder 115. That is to say, the decoder 103 typically decodes video frames at a different rate than the encoder 115 encodes video frames. Therefore, video frames are not only stored in the reorder buffer 105 so as to be reordered, but are also temporarily stored as the encoder 115 and the decoder 103 process at different rates. While the video frames are stored in the reorder buffer 105, the modules 104, 107, 109, 111, and 113 access the reorder buffer 105 and modify the video frames stored therein. This aids the encoder 115 in increasing throughput.

Referring now to FIG. 2, a block diagram illustrating a video processing device 201 that utilizes a reorder buffer 219 that is accessed for FRC and for a plurality of post-processing functions is discussed and described. The video processing device 201 may include one or more processing unit 203, a transceiver 207, an input mechanism 209, and a display mechanism 213. The processing unit 203 includes a processor 205 coupled to a memory 215. The processor 205 is coupled to, and receives input from, the transceiver 203 and the input mechanism 209. Further, the processor 205 is coupled to, and provides output to, a display mechanism 213 and/or the transceiver 207.

It should be noted that the term video processing device is an identifying label and can be broadly construed to include a variety of different devices. Exemplary network infrastructure devices include those providing or facilitating video image streaming such as servers, edge routers, centralized media gateways, session border controllers, trunk gateways, media boxes, call servers, and the like, and variants or evolutions thereof. This list is not intended as being exhaustive.

The video processing device 201 is equipped to receive video frames wirelessly or from a wired connection. Further, although embodiments of the present application discussed herein in detail refer to video frames being received over a network, it should be noted that the video processing device 201 may also receive video frames from a tangible storage medium. More detail related to the components and operation of the video processing device 201 is now provided.

As mentioned above, the processing unit 203 includes the processor 205 and memory 215. The processor 215 could include a digital signal processors (DSP), general purpose programmable processor, application specific circuit, a system on a chip (SoC) such as a multi-core processor array, and/or combinations such as a DSP and a RISC processor together with various specialized programmable accelerators. This list is not intended as being exhaustive.

The memory 215, coupled to the processor 205, may comprise a read-only memory (ROM), a random-access memory (RAM), a programmable ROM (PROM), an electrically erasable read-only memory (EEPROM), and/or a ferroelectric random access memory (FRAM). The memory 215 may be a double data rate (DDR) memory. The memory 215 may include multiple memory locations for storing, among other things, an operating system, data and variables 217 for operations executed by the processor 409. The memory includes a memory location serving as the reorder buffer 219. The memory 215 may further include multiple memory locations for storing instructions/programs 221, 223, 225, 226, 227, 229 executed by the processor 205. The memory 215 may further include memory locations for other instructions and/or miscellaneous data 231 that are used by the processor 205.

The transceiver 207 is representative of a receiver, a transceiver, a port or other type of connection for wireless or wired communication with a device or peripheral external or internal to the video processing device 201, which receives video frames which are then processed in the processing unit 203. In embodiments in which the video processing device also supports user functions, a user may invoke accessible functions through the input mechanism 209. The user input mechanism 209 may comprise one or more of various known input devices, such as a keypad, a computer mouse, a touchpad, a touch screen, a trackball, and/or a keyboard. In embodiments in which the video processing device 201 is a playback device capable of displaying processed video frames, the display mechanism 213 may present images from the video frames processed by the processor 205 by way of a conventional liquid crystal display (LCD) or other visual display.

As mentioned above, the memory 215 may include multiple memory locations for storing instructions/programs 221, 223, 225, 226, 227, 229 executed by the processor 205. These instructions/programs include: decoding 221 a plurality of video frames; after decoding, storing 223 the plurality of video frames in a reorder buffer 219; accessing 225 the plurality of video frames while the plurality of video frames are stored in the reorder buffer 219, and reordering 225 the plurality of video frames, while the plurality of video frames are stored in the reorder buffer 219, from a streamed order into a display order; accessing 226 the plurality of video frames while the plurality of video frames are stored in the reorder buffer 219, and adjusting 226 a frame rate by interpolating frames from the plurality of video frames, while the plurality of video frames are stored in the reorder buffer 219; accessing 227 the plurality of video frames while the plurality of video frames are stored in the reorder buffer 219, and making 227 one or more post-processing modification to the plurality of video frames, while the plurality of video frames are stored in the reorder buffer 219; and outputting 229 from the video processing device, in display order, the plurality of frames stored in the reorder buffer 219.

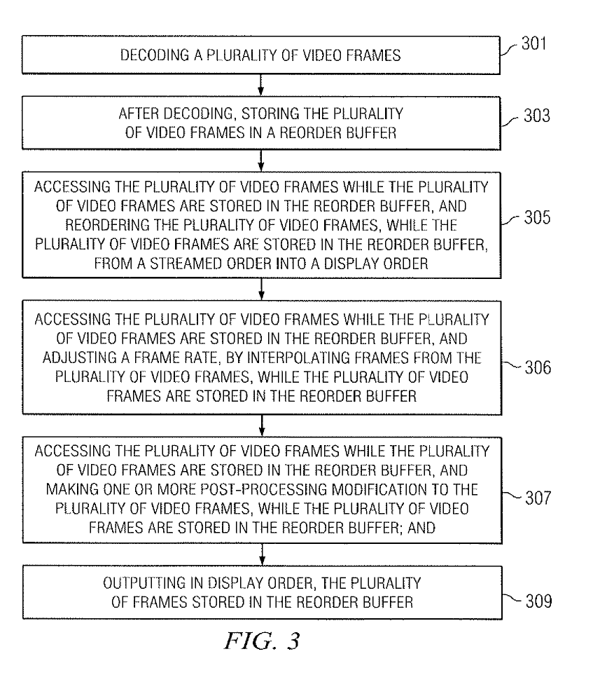

Referring now to FIG. 3, a flow chart illustrating a video processing method implemented in a video processing device that utilizes a reorder buffer that is accessed for FRC and for a plurality of post-processing functions is discussed and described. The method includes decoding 301 a plurality of video frames. After decoding, the method includes storing 303 the plurality of video frames in the reorder buffer in the memory. The method further includes accessing 305 the plurality of video frames while the plurality of video frames are stored in the reorder buffer, and reordering 305 the plurality of video frames, while the plurality of video frames are stored in the reorder buffer, from a streamed order into a display order. The method also includes accessing 306 the plurality of video frames while the plurality of video frames are stored in the reorder buffer, and adjusting 306 a frame rate by interpolating frames from the plurality of video frames, while the plurality of video frames are stored in the reorder buffer. The method additionally includes accessing 307 the plurality of video frames while the plurality of video frames is stored in the reorder buffer, and making 307 one or more post-processing modification to the plurality of video frames, while the plurality of video frames are stored in the reorder buffer. Finally, the method includes outputting 309 from the video processing device, in display order, the plurality of frames stored in the reorder buffer.

As used herein, the phrase “video frame” indicates the information representing just one of many still images which compose a complete video, and which can be represented as an array of picture elements (for example, color and luminance) and/or motion vectors, as may be further defined in standards such as MPEG1/2/4/7/H.264/VC-1/AVS, variants and evolutions thereof.

As used herein the terms “reorder”, “reorders”, “reordered”, and “reordering” indicate either the physical transferring of video frames such that the video frames are stored in a predetermined correct display order in adjacent memory locations, or manipulating pointer information so that the video frames are accessed in memory locations in the predetermined correct display order.

As used herein, the phrase “reorder buffer” indicates an area of memory used for storing video frames that will be reordered, typically a predefined location in low-order memory which can be quickly accessed by programs executed in a processor, e.g., a DDR.

As used herein, the phrase “frame rate conversion” indicates the process of transforming from one standard frame rate to another, using a known algorithm.

As used herein, the terms “decodes”, “decodes”, and “decoding” indicate known techniques for reversing a previously used encoding process, for example reversing a previously used compression process.

As used herein, the terms “read”, “reads”, or “reading” indicates known techniques for using read access to memory to determine the contents of memory.

As used herein, the phrase “post-processing” indicates known techniques for signal processing, performed after decoding, in which various mathematical operations are applied to video frame data in order to create enhanced images that are more useful or pleasing to a human observer, or to perform some of the interpretation and recognition tasks usually performed by humans.

The foregoing description is not intended to be exhaustive or to limit the invention to the precise form disclosed. Modifications or variations are possible in light of the above teachings. The embodiments were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A video processing device, comprising:
a processor; and
a memory, wherein
the processor includes a decoding module that decodes a plurality of video frames;
the memory includes a reorder buffer that stores the plurality of video frames decoded by the decoding module;
the processor includes a reorder module that accesses the plurality of video frames while the plurality of video frames are stored in the reorder buffer, and reorders the plurality of video frames, while the plurality of video frames are stored in the reorder buffer, from a streamed order into a display order;
the processor includes a frame rate conversion module that accesses the plurality of video frames while the plurality of video frames are stored in the reorder buffer, and adjust a frame rate, by interpolating frames from the plurality of video frames, while the plurality of video frames are stored in the reorder buffer;
the processor includes one or more post processing module that accesses the plurality of video frames while the plurality of video frames are stored in the reorder buffer, and makes one or more post-processing modification to the plurality of video frames, while the plurality of video frames are stored in the reorder buffer; and
the processor includes an output module that outputs from the video processing device, in display order, the plurality of video frames stored in the reorder buffer.

2. A video processing device according to claim 1, wherein
the processor further includes an encoder that reads the plurality of video frames while the plurality of video frames are stored in the reorder buffer, copies the plurality of video frames stored in the reorder buffer as a plurality of copied video frames, and encodes the plurality of copied video frames into a compression format.

3. The video processing device according to claim 1, wherein
the one or more post-processing module includes a transizing module that transizes the plurality of video frames, while the plurality of video frames are stored in the reorder buffer.

4. The video processing device according to claim 1, wherein
the one or more post-processing module includes an image de-noising module that de-noises the plurality of video frames, while the plurality of video frames are stored in the reorder buffer.

5. The video processing device according to claim 1, wherein
the one or more post-processing module includes an image enhancement/sharpening module that image enhances and/or sharpens the plurality of video frames stored in the reorder buffer, while the plurality of video frames are stored in the reorder buffer.

6. The video processing device according to claim 1, wherein
the one or more post-processing module includes an overlay module that overlays content onto the plurality of video frames, while the plurality of video frames are stored in the reorder buffer.

7. The video processing device according to claim 1, wherein
the plurality of video frames that are decoded by the decoding module are received from an external device that provides the plurality of video frames over an intranet.

8. The video processing device according to claim 1, wherein
the plurality of video frames that are decoded by the decoding module are received from an external device that provides the plurality of video frames over the Internet.

9. A video processing method implemented in a video processing device, including a processor and a memory, comprising:
decoding a plurality of video frames;
after decoding, storing the plurality of video frames in a reorder buffer in the memory;
accessing the plurality of video frames while the plurality of video frames are stored in the reorder buffer, and reordering the plurality of video frames, while the plurality of video frames are stored in the reorder buffer, from a streamed order into a display order;
accessing the plurality of video frames while the plurality of video frames are stored in the reorder buffer, and adjusting a frame rate by interpolating frames from the plurality of video frames, while the plurality of video frames are stored in the reorder buffer;
accessing the plurality of video frames while the plurality of video frames are stored in the reorder buffer, and making one or more post-processing modification to the plurality of video frames, while the plurality of video frames are stored in the reorder buffer; and
outputting from the video processing device, in display order, the plurality of frames stored in the reorder buffer.

10. The method according to claim 9, further comprising:
reading the plurality of video frames while the plurality of video frames are stored in the reorder buffer, copying the plurality of video frames stored in the reorder buffer as a plurality of copied video frames, and encoding the plurality of copied video frames into a compression format.

11. The method according to claim 9, wherein
making one or more post-processing modification includes transizing the plurality of video frames, while the plurality of video frames are stored in the reorder buffer.

12. The method according to claim 9, wherein
making one or more post-processing modification includes de-noising the plurality of video frames, while the plurality of video frames are stored in the reorder buffer.

13. The method according to claim 9, wherein
making one or more post-processing modification includes enhancing and/or sharpening the plurality of video frames, while the plurality of video frames are stored in the reorder buffer.

14. The method according to claim 9, wherein
making one or more post-processing modification includes overlaying content onto the plurality of video frames, while the plurality of video frames are stored in the reorder buffer.

15. A computer-readable storage medium with instructions stored thereon, that when executed by a processor in a video processing device, perform a method comprising:
decoding a plurality of video frames;
after decoding, storing the plurality of video frames in a reorder buffer;
accessing the plurality of video frames while the plurality of video frames are stored in the reorder buffer, and reordering the plurality of video frames, while the plurality of video frames are stored in the reorder buffer, from a streamed order into a display order;
accessing the plurality of video frames while the plurality of video frames are stored in the reorder buffer, and adjusting a frame rate by interpolating frames from the plurality of video frames, while the plurality of video frames are stored in the reorder buffer;
accessing the plurality of video frames while the plurality of video frames are stored in the reorder buffer, and making one or more post-processing modification to the plurality of video frames, while the plurality of video frames are stored in the reorder buffer; and
outputting from the video processing device, in display order, the plurality of frames stored in the reorder buffer.

16. The computer-readable storage medium of claim 15, wherein the method further comprises:
reading the plurality of video frames while the plurality of video frames are stored in the reorder buffer, copying the plurality of video frames stored in the reorder buffer as a plurality of copied video frames, and encoding the plurality of copied video frames into a compression format.

17. The computer-readable storage medium of claim 15, wherein
making one or more post-processing modification includes transizing the plurality of video frames, while the plurality of video frames are stored in the reorder buffer.

18. The computer-readable storage medium of claim 15, wherein
making one or more post-processing modification includes de-noising the plurality of video frames, while the plurality of video frames are stored in the reorder buffer.

19. The computer-readable storage medium of claim 15, wherein
making one or more post-processing modification includes enhancing and/or sharpening the plurality of video frames, while the plurality of video frames are stored in the reorder buffer.

20. The computer-readable storage medium of claim 15, wherein
making one or more post-processing modification includes overlaying content onto the plurality of video frames, while the plurality of video frames are stored in the reorder buffer.
